(19) United States
(12) Patent Application Publication
(10) Pub. No.: US 2012/0205412 A1
(43) Pub. Date: Aug. 16, 2012

(54) MOUNTING DEVICE FOR HOLDING A PORTABLE DEVICE WITHIN A CAR

(76) Inventor: Young K. Choi, Tacoma, WA (US)

(21) Appl. No.: 13/025,450

(22) Filed: Feb. 11, 2011

(51) Int. Cl. B60R 7/06; B60R 11/00

(52) U.S. Cl. 224/483; 224/545

(57) ABSTRACT

Mounting devices for holding portable devices within the interior of a car can include a clamp which attaches one end of an arm structure of a car's rear view mirror and a holder for holding a portable device at the other end. The mounting devices can also include a clamp which attaches one end of an arm structure of a car's rear view mirror and a holder for holding a single suction cup mounting device at the other end. The arm of the mounting devices may include any number of rotational adjustors, length adjustors, or any combination thereof, to allow the driver to sufficiently adjust the position of the arm according to the driver's needs. The mounting devices may also include either or both of a windshield brace arm and a dash board brace arm to increase the stability of the mounting device.

### TECHNICAL FIELD

The subject matter described herein relates generally to mounting portable devices within the interior of a car. More particularly, the subject matter relates to a device which can securely hold a portable device, such as a Global Positioning System (GPS) unit, cell phone, or other similar device, and mounts to the support structure of a rear view mirror within the car.

### BACKGROUND

Car drivers often want access to portable devices while they are driving. Such portable devices may include GPS units, cell phones, and the like. Holding these devices may hinder a driver's ability to safely operate the car. In addition, many jurisdictions have laws which do not allow drivers to hold portable devices in their hands while driving. Furthermore, portable devices, such as GPS units, may not operate effectively while being held by a driver. However, most cars are not equipped to hold these portable devices for the driver.

Mounting devices have been developed for holding portable devices within the interior of cars. One example is a single suction cup mounting device. A single suction cup mounting device generally has a suction cup which can attach to a windshield of a car. The suction cup is the sole point of contact between the single suction cup mounting device and the car. Single suction cup mounting devices often have a rigid cover over the suction cup, an arm extending from the rigid structure, and a portable device holder attached to the end of the arm extending from the rigid structure. However, these single suction cup mounting devices suffer from several drawbacks. First, a single suction cup often cannot withstand the vibrations of the car when being driven. As a result, the single suction cup can lose its suction, causing the entire single suction cup mounting device with the portable device to fall while the driver is driving the car. Second, single suction cup mounting devices often have limited ability to be adjusted to the various makes and models of cars. Thus, certain designs of dashboards and windshields make it difficult for the driver to comfortably see and reach the portable device while the driver is seated in the driver's seat. Third, suction cups are generally made from pliable materials that wear out quickly. These pliable materials can become brittle and they may develop defects, such as scratches. All of these issues limit the ability of the suction cup to create a secure seal with the windshield, thus limiting the effectiveness of the suction cup to maintain its hold to the windshield.

### SUMMARY

The present invention relates to a mounting device for holding portable devices. One embodiment of a mounting device includes a clamp which attaches to the structure of a car's rear view mirror, a holder for holding a portable device, and an arm extending between the clamp and the holder. Another embodiment of a mounting device includes a clamp which attaches to the structure of a car's rear view mirror, a holder for holding a rigid structure of a single suction cup mounting device, and an arm extending between the clamp and the holder. The arm of the mounting device may include any number of rotational adjustors and length adjustors to allow the driver to sufficiently adjust the position of the arm according to the driver's needs. The arm may also include a secondary arm attachment point which can be attached to either or both of a windshield brace arm and a dash board brace arm to increase the stability of the mounting device.

### BRIEF DESCRIPTION OF THE DRAWINGS

FIGS. 1, 2, and 3 depict a side view, front view, and partial top view, respectively, of one embodiment of a mounting device.

FIGS. 4A, 4B, and 4C depict an embodiment of a clamp for connecting a mounting device to a rear view mirror support structure.

FIG. 5 depicts a single suction cup mounting device.

FIGS. 6A, 6B, and 6C depict views of an embodiment of a mounting device which is configured to hold a single suction cup mount.

FIGS. 7, 8, and 9 depict embodiments of a mounting device which includes either or both of a dashboard brace arm and a windshield brace arm.

FIG. 10 depicts an embodiment of a portable device holder.

### DETAILED DESCRIPTION OF ILLUSTRATIVE EMBODIMENTS

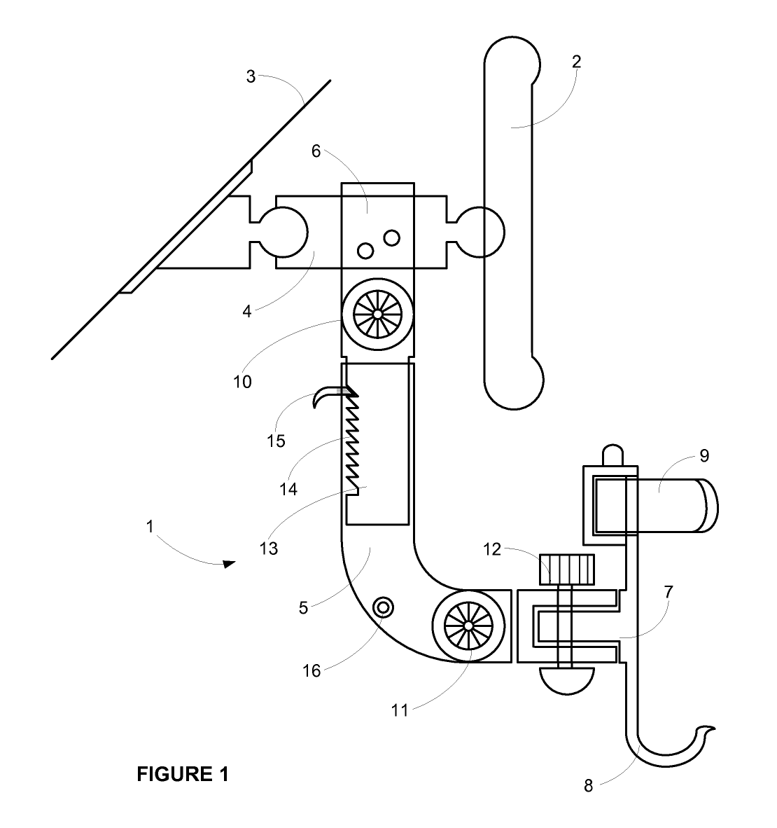

FIG. 1 depicts a side view of one embodiment of a mounting device 1. As shown in FIG. 1, most cars have a rear view mirror 2 which is attached to the windshield 3 via a support structure 4. The support structure 4 can include an arm with one or more ball joints, as depicted here. However, there are many forms of the support structure 4 depending on the particular make and model of the car. The mounting device 1 includes an arm 5 with a clamp 6 at one end for securely holding the mounting device 1 to the support structure 4. The mounting device 1 also includes a portable device holder 7 at another end for holding a portable device. The portable device holder 7 may include structure such as a lower brace 8 and adjustable arms 9 depicted in FIG. 1. However, the portable device holder 7 may take any number of forms depending on the shape and size of the portable devices to be held.

The arm 5 may include rotational adjustors 10, 11, 12, and length adjustor 13 to allow the driver to sufficiently adjust the position and length of the arm 5 according to the driver's needs. The arm 5 depicted in FIG. 1 includes a rotational adjustor 10 near the clamp 6. The rotational adjustor 10 has a horizontal axis which allows adjustment of the angle of the arm 5 with respect to support structure 4. Rotational adjustor 10 can be especially helpful where the support structure 4 is not arranged horizontally. The arm 5 depicted in FIG. 1 also includes two rotational adjustors 11 and 12 which are located near the portable device holder 7. As depicted, rotational adjustor 11 has a horizontal axis and rotational adjustor 12 has a vertical axis. The combination of two rotational adjustors 11 and 12 with orthogonal axes allows the driver to position the portable device holder 7 at nearly any desired angle. The two rotational adjustors 11 and 12 can also be replaced with a single ball joint to give the driver the option of adjusting the portable device holder 7 at nearly any desired angle.

The arm 5 may also include a length adjustor 13, as depicted in FIG. 1. The length adjustor 13 allows the driver to change the length of the arm 5 as desired. In the embodiment depicted in FIG. 1, the length adjustor may include a set of linear ratchet teeth 14 and a pawl lever 15 which allows a driver to engage or disengage the pawl lever 15 from the ratchet teeth 14. Engagement of the pawl lever 15 to the ratchet teeth 14 releasably holds the length adjustor at a certain position. Disengagement of the pawl lever 15 from the ratchet teeth 14 allows the length adjustor to move freely. Other embodiments for length adjustor 13 may include telescoping tubes, tubes with incremented push button locking holes, and the like.

The arm 5 may also include a brace arm attachment point 16 which can be used to attach one or more brace arms (not depicted). Braces arms, such as windshield brace arms and dash board brace arms discussed in greater detail below. Brace arms can be used to increase the stability of mounting device 1. The attachment point 16 may be as simple as a hole in arm 5 to which a brace arm may be attached using a screw, a rivet, or other attachment device.

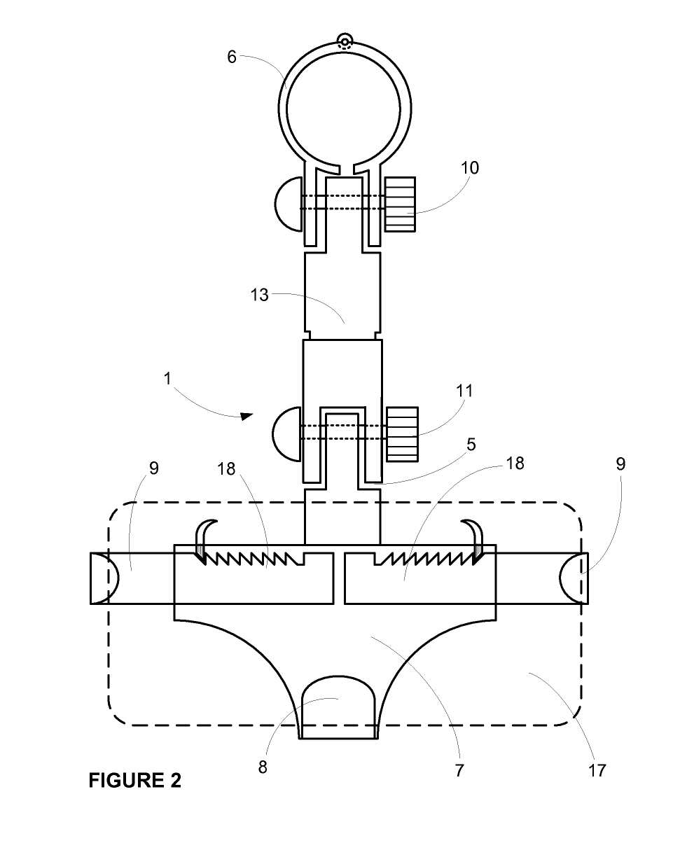

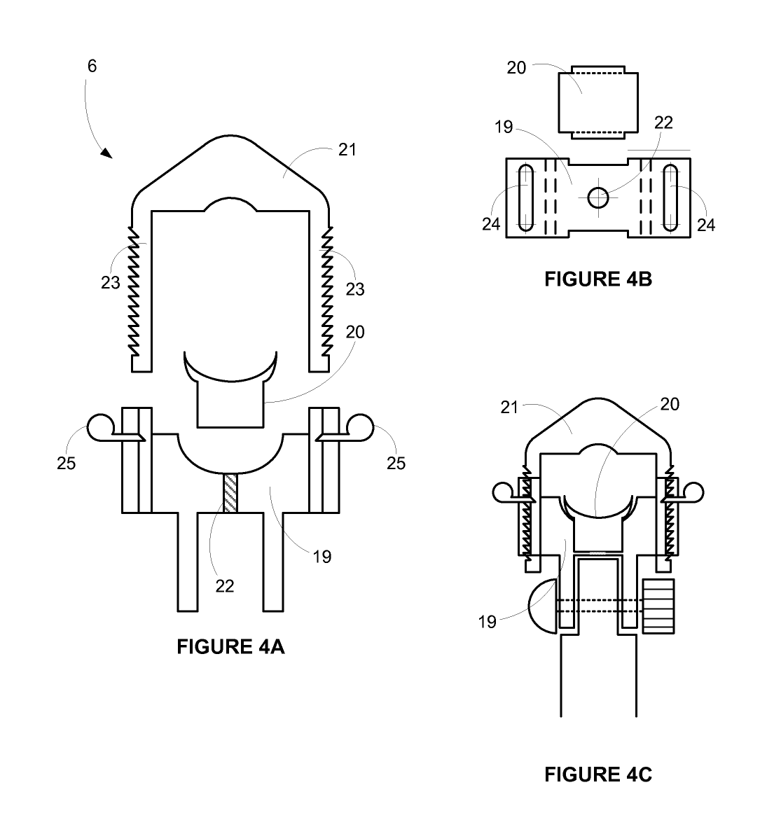

FIG. 2 depicts a front view of mounting device 1. The clamp 6 depicted in FIG. 2 has a circular shape to fit around a support structure 4 that has a circular cross section. However, other embodiments of clamp 6 are possible, such as the embodiment discussed below with respect to FIGS. 4A, 4B, and 4C. As further shown in FIG. 2, portable device holder 7 can hold a portable device 17. The portable device 17 can be supported from the bottom by lower brace 8 and on the sides by adjustable arms 9. Adjustable arms 9 can include length adjustors 18 which allow the adjustable arms 9 to be releasably held in a certain position. Length adjustors 18 can have any number of embodiments, such as the ratchet teeth and lever embodiment depicted in FIG. 2, or any other embodiment, such as telescoping tubes, tubes with incremented push button locking holes, and the like.

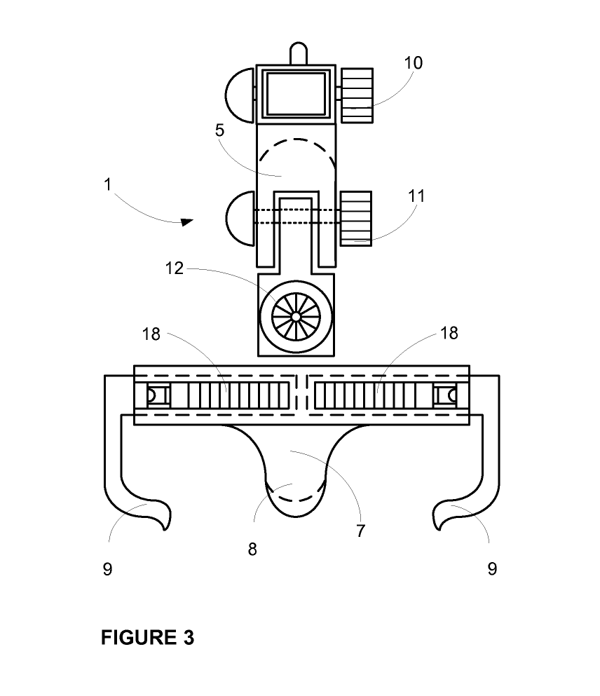

FIG. 3 depicts a partial top view of one embodiment of a mounting device 1. The depiction in FIG. 3 is a partial top view in that it does not depict clasp 6. Mounting device 1 is depicted with arm 5, rotational adjusters 10, 11, 12, and portable device holder 7. Portable device 7 is depicted with lower brace 8 and adjustable arms 9 which each have a length adjustor 18.

FIG. 4A depicts an exploded view of an embodiment of clamp 6. As shown, clamp 6 can include a base 19, a compression part 20, and a cap 21. FIG. 4B depicts top views of base 19 and compression part 20. FIG. 4C depicts a view of this embodiment of claim 6 as it would be installed on a rear view mirror structure. Base 19 can include a threaded hole 22 which can receive a screw (not shown), such as a set screw. Compression part 20 can be placed on top of base 19 over threaded hole 22. Cap 21 includes two sets of linear ratchet teeth 23. Linear ratchet teeth 23 can be slid through slats 24 in base 19 to interface with pawl levers 25. When pawl levers 25 engage ratchet teeth 23, cap 21 is prevented from moving upward until pawl levers 25 are disengaged. Cap 21 can be made of a flexible material or a rigid material.

To install this embodiment of claim 6 onto a rear view mirror structure, the compression part 20 is placed on top of base 19 over threaded hole 22. Base 19 and compression part 20 are placed under the rear view mirror structure such that compression part 20 contacts the rear view mirror structure. Cap 21 is slid down on top of rear view mirror structure and ratchet teeth 23 are slid through slats 24 of base 19 such that the rear view mirror structure is held between compression part 20 and cap 21. The installer pushes the base 19 and cap 21 toward each other by hand such that the clamp 6 is held in place on the rear view mirror structure. The installer can then insert a screw, such as a set screw, into threaded hole 22 of base 19 to exert an upward force on compression part 20. As the screw is tightened, it pushes the compression part 20 into the rear view mirror support structure such that clamp 6 is securely attached to rear view mirror structure.

As depicted in FIG. 4C, this embodiment of claim 6 is configured to attach to rear view mirror structures that have a variety of cross section shapes, including circular cross sections and rectangular cross sections. Such a configuration allows the clamp 6 to be used on a wide range of makes and models of cars.

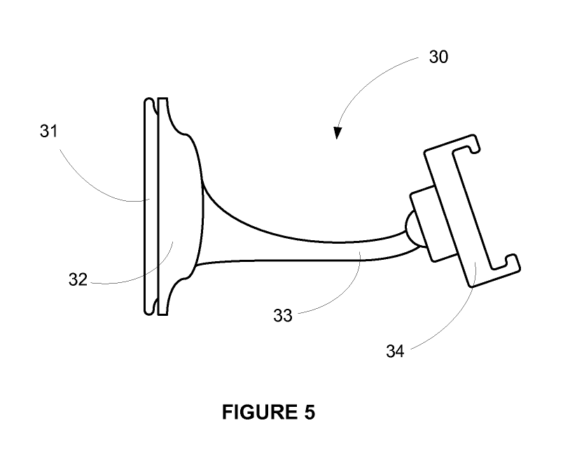

FIG. 5 depicts a single suction cup mount 30. Single suction cup mount 30 includes a suction cup 31, a rigid structure 32 covering suction cup 31, an arm 33, and a portable device holder 34. Many portable devices, such as GPS units, are sold with a single suction cup mount 30 which has portable device holder 34 that is specifically designed to hold the portable device with which it is sold. Many drivers prefer to use the portable device holder 34 that is sold with their portable device. However, the single suction cup mount 30 has the disadvantages of single suction cup mounting devices discussed above.

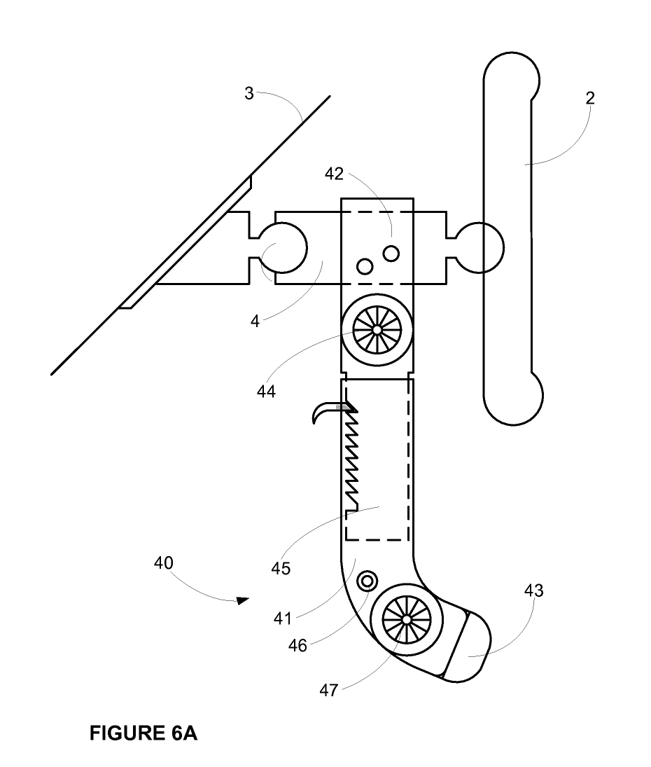

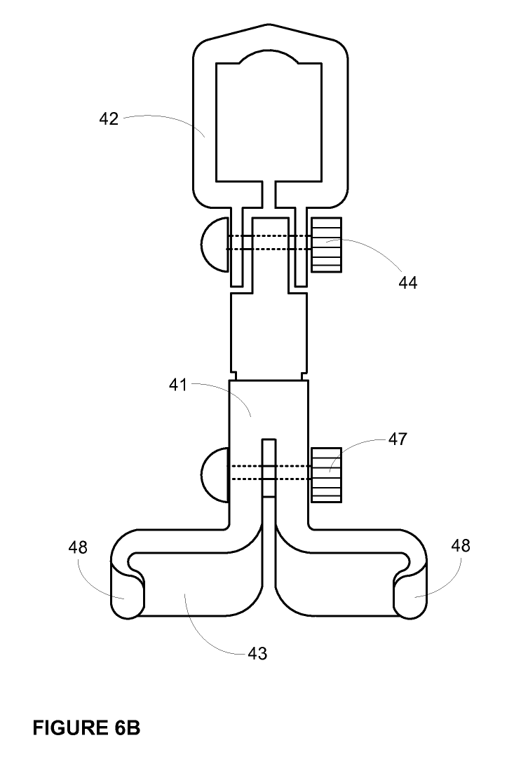

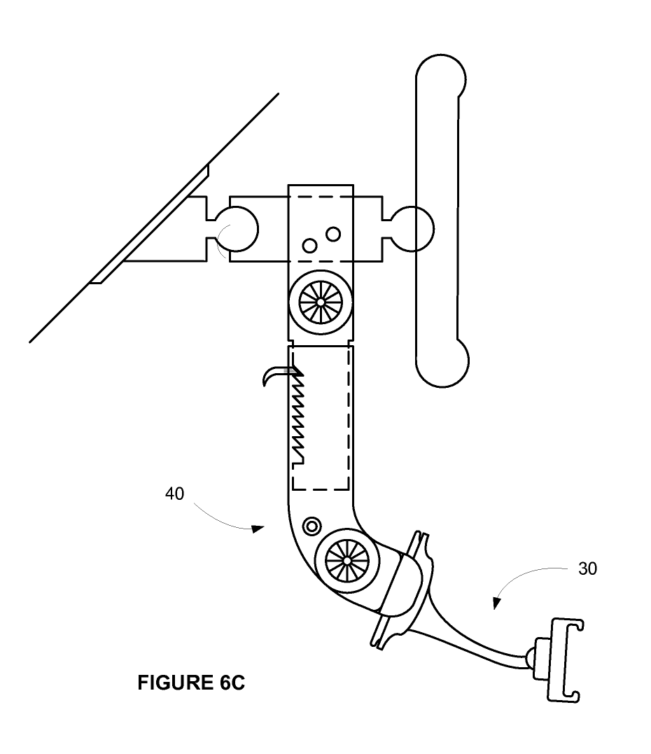

FIGS. 6A, 6B, and 6C depict views of another embodiment of a mounting device 40 which can hold the rigid structure 32 of a single suction cup mount 30. Mounting device 40 includes an arm 41 which has a clamp 42 at one end and a suction cup mount holder 43 at the other end. Mounting device 40 can include rotational adjustor 44, length adjustor 45, and attachment point 46 similar to rotational adjustor 10, length adjustor 13, and attachment point 16 described above with respect to FIG. 1. A compression device 47 can be included on mounting device 40 to secure suction cup mount holder 43 to the rigid structure 32 of a single suction cup mount 30.

FIG. 6B depicts a front view of mounting device 40. As shown, suction cup mount holder 43 has two arms 48. The arms are designed to hold the rigid structure 32 which covers the suction cup 31 of a single suction cup mount 30. The rigid structure 32 can be slid into arms 48 such that the arms 48 are approximately on opposite ends of rigid structure 32. Once the rigid structure 32 is in place between arms 48, compression device 47 can be tightened until suction cup mount holder 43 securely holds the rigid structure 32 of single suction cup mount 30. FIG. 6C depicts single suction cup mount 30 being held by mounting device 40. As depicted in FIG. 6C, mounting device 40 allows a driver to use the portable device holder 34 of the single suction cup mount 30 that was sold with the driver's portable device, but eliminates the need to use suction cup 31 to secure the portable device to the windshield.

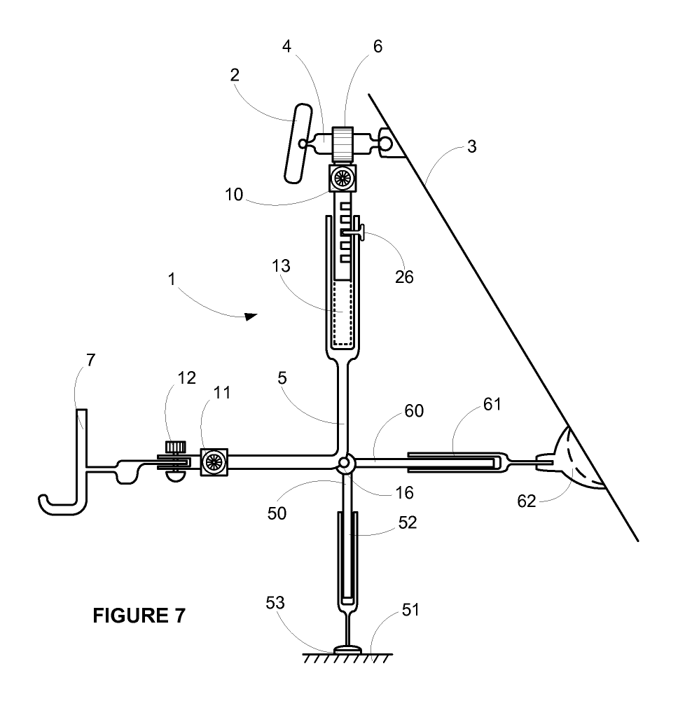

FIGS. 7, 8, and 9 depict mounting device 1 with optional brace arms. FIG. 7 depicts an embodiment of mounting device 1 which is similar to the mounting device 1 depicted in FIG. 1. FIG. 7 also depicts another embodiment of length adjustor 13. In this embodiment, when securing pin 26 is engaged, length adjustor 13 is prevented from moving freely. When securing pin 26 is disengaged, length adjustor 13 can move freely.

FIG. 7 also depicts a dash board brace arm 50 which is attached to arm 5 at attachment point 16. Dash board brace arm 50 extends toward dash board 51 and includes a length adjustor 52 which allows the dash board brace arm 50 to be adjusted to a wide variety of car makes and models. Dash board brace arm 50 also includes a foot 53 for contacting the dash board 51. The foot 53 can be a releasable connector, such as a suction cup, or it can be a material, such as rubber, which resists motion between dash board brace arm 50 and dash board 51.

FIG. 7 also depicts a windshield brace arm 60 which is attached to arm 5 at attachment point 16. Windshield brace arm 60 extends toward windshield 3 and includes a length adjustor 61 which allows the windshield brace arm 60 to be adjusted to a wide variety of car makes and models. Windshield brace arm 60 also includes a windshield connector 62, such as a suction cup, which releasably connects windshield brace arm 60 to windshield 3.

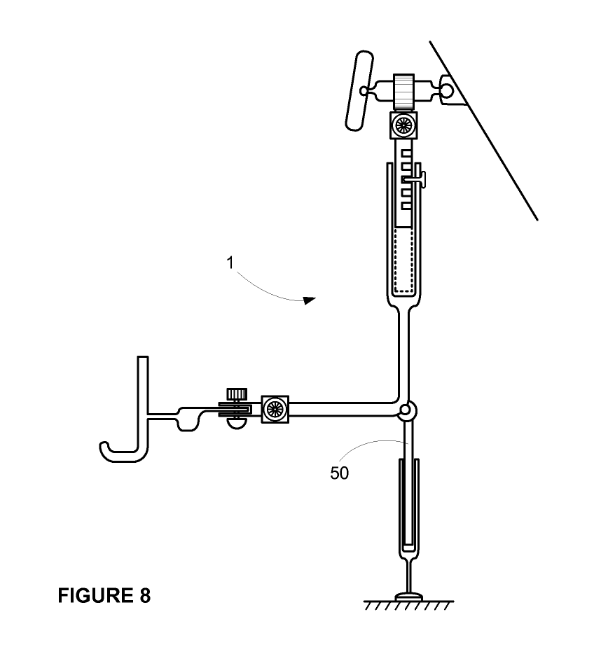

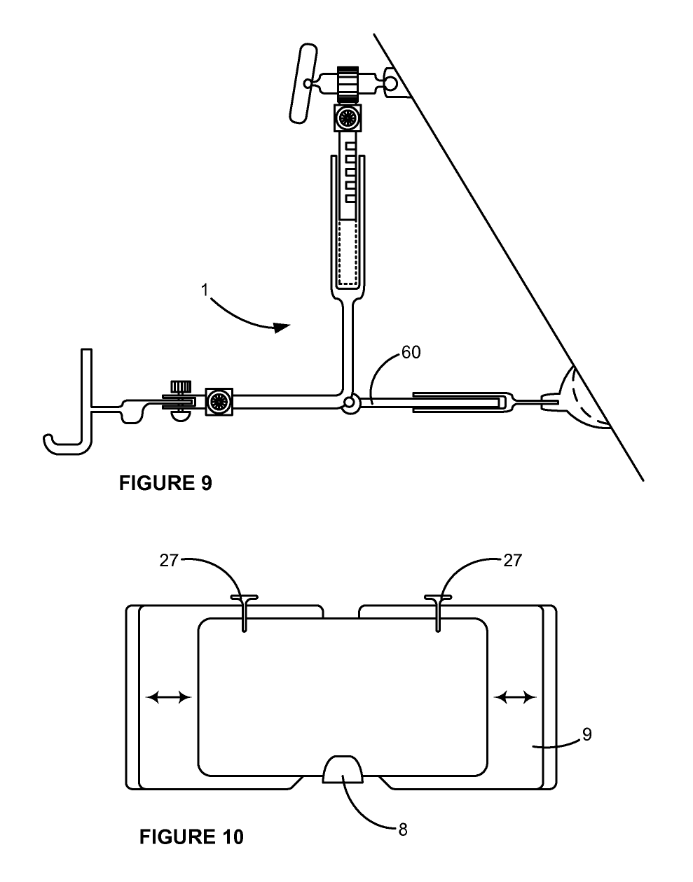

As described above with respect to FIG. 1, the use of brace arms with mounting device 1 is optional. However, As depicted in FIG. 7, mounting device 1 can be connected to both a dash board brace arm 50 and a windshield brace arm 60. Further, as depicted in FIG. 8, mounting device 1 can be used with a dash board brace arm 50 alone. As depicted in FIG. 9, mounting device 1 can be used with a windshield brace arm 60 alone. The use of one or more brace arms can increase the stability of a mounting device by providing another point of contact between the mounting device and the car.

FIG. 10 depicts an embodiment of holder 7. As depicted here, holder 7 has a lower brace 8 and adjustable arms 9. Adjustable arms 9 can be moved horizontally to accommodate portable devices of various widths. In addition, pins 27 can be used to prevent adjustable arms 9 from moving freely. A driver may find such a feature to be helpful as the driver may repeatedly use the same portable device in holder 7 and may not want to adjust the position of adjustable arms 9 each time the same portable device is placed in holder 7.

While the above description contains many specifications, these should not be construed as limitations on the scope of the invention, but rather as examples of embodiments of the invention. Many other variations on the mounting device are possible. Therefore, the scope of the invention should not be limited to those specific embodiments depicted and described above, but by the claims which follow.

What is claimed:

1. A mounting device for holding a portable device within the interior of a car, the mounting device comprising:
a clamp configured to securely attach the mounting device to a support structure of a rear view mirror;
a portable device holder configured to hold a portable device;
an arm extending between the clamp and the portable device holder, wherein the arm comprises an arm length adjustor configured to adjust the length of the arm;
a first rotatable adjustor configured to allow the arm to rotate with respect to the clamp; and
a second rotatable adjustor configured to allow the portable device holder to rotate with respect to the arm.

2. The mounting device of claim 1, wherein the first rotatable adjustor is configured to rotate about one axis.

3. The mounting device of claim 1, wherein the second rotatable adjustor is configured to rotated about two orthogonal axes.

4. The mounting device of claim 1, wherein the clamp comprises a base, a cap, and a compression part, and wherein the clamp is configured to securely attach the mounting device to the support structure with the support structure between the compression part and the cap.

5. The mounting device of claim 4, wherein the cap comprises at least two sets of ratchet teeth and wherein the base comprises at least two pawl levers, and wherein each of the at least two pawl levers is configured to contact one of the at least two sets of ratchet teeth.

6. The mounting device of claim 5, wherein the clamp further comprises a screw configured to exert a force on the compression part.

7. The mounting device of claim 1, further comprising:
a dash board brace arm attached to the arm.

8. The mounting device of claim 7, wherein the dash board brace arm comprises:
a dash board brace arm length adjustor configured to adjust the length of the dash board brace arm; and
a foot configured to contact a dash board.

9. The mounting device of claim 1, further comprising:
a windshield brace arm attached to the arm.

10. The mounting device of claim 7, wherein the windshield brace arm comprises:
a windshield arm length adjustor configured to adjust the length of the windshield brace arm; and
a windshield connector configured to connect the windshield brace arm to a windshield.

11. The mounting device of claim 1, further comprising:
a dash board brace arm attached to the arm; and
a windshield brace arm attached to the arm.

12. A mounting device for holding a single suction cup mounting device within the interior of a car, the mounting device comprising:
a clamp configured to securely attach the mounting device to a support structure of a rear view mirror;
a holder configured to hold a rigid structure of a single suction cup mounting device, wherein the rigid structure covers a suction cup of the single suction cup mounting device;
an arm extending between the clamp and the holder, wherein the arm comprises an arm length adjustor configured to adjust the length of the arm; and
a rotatable adjustor configured to allow the arm to rotate with respect to the clamp.

13. The mounting device of claim 12, wherein the rotatable adjustor is configured to rotate about one axis.

14. The mounting device of claim 12, further comprising a compression device configured to compress two arms of the holder against the rigid structure.

15. The mounting device of claim 12, wherein the clamp comprises a base, a cap, and a compression part, and wherein the clamp is configured to securely attach the mounting device to the support structure with the support structure between the compression part and the cap.

16. The mounting device of claim 15, wherein the cap comprises at least two sets of ratchet teeth and wherein the base comprises at least two pawl levers, and wherein each of the at least two pawl levers is configured to contact one of the at least two sets of ratchet teeth.

17. The mounting device of claim 16, wherein the clamp further comprises a screw configured to exert a force on the compression part.

18. The mounting device of claim 12, further comprising a dash board brace arm attached to the arm, wherein the dash board brace arm comprises:
a dash board brace arm length adjustor configured to adjust the length of the dash board brace arm; and
a foot configured to contact a dash board.

19. The mounting device of claim 12, further comprising a windshield brace arm attached to the arm, wherein the windshield brace arm comprises:
a windshield arm length adjustor configured to adjust the length of the windshield brace arm; and
a windshield connector configured to connect the windshield brace arm to a windshield.

20. The mounting device of claim 12, further comprising:
a dash board brace arm attached to the arm; and
a windshield brace arm attached to the arm.
